(19) United States
(12) Patent Application Publication
(10) Pub. No.: US 2012/0156632 A1
(43) Pub. Date: Jun. 21, 2012

(54) METHOD AND APPARATUS FOR DENTAL DEVICE

(76) Inventor: Marc I. Schiller, Parsippany, NJ (US)

(21) Appl. No.: 12/970,305

(22) Filed: Dec. 16, 2010

(51) Int. Cl. A61C 19/04; A61C 7/28

(52) U.S. Cl. 433/10; 433/24

(57) ABSTRACT

An apparatus including a device including fluoride is provided. The device may be configured to be held by a dental bracket and to hold a dental arch wire in place. The device may alternatively, or additionally, include calcium phosphate. The device may be a dental ligature or a dental cap. The apparatus may include the dental bracket. The fluoride may be configured to leach out of the device as part of a material which leaches out of the device, and the amount of fluoride in the material may be less than one part of fluoride per million parts of material. A method is also provided including placing a device including fluoride in a person's mouth so the device is held by a dental bracket and holds a dental arch wire in place. The device may be as previously described.

### FIELD OF THE INVENTION

This invention relates to improved methods and apparatus concerning dental devices.

### BACKGROUND OF THE INVENTION

Dental brackets, and in particular orthodontic brackets are usually bonded on to a tooth with composite cement. The bracket acts like a handle on a pitcher to control the direction that a tooth moves. The movement of the tooth is controlled by a wire, called an arch wire and/or elastic bands. One huge problem with patients is the collection of food around the bracket which leads to a bacterial explosion on the tooth enamel. This subsequently leads to the enamel being attacked by the bacteria which causes enamel decalcification or a weakening of the enamel. Weakening of the enamel is caused by a dissipation of the calcium and phosphate from the enamel surface of the tooth. A decalcification area presents as a white spot on the surface of a tooth and can result in a softening of the enamel and/or a hole in the enamel surface.

Dentists use enamel sealants, fluoride toothpastes, and fluoride rinses to help prevent this. One recent dental cement, glass ionomer contains fluoride and has been shown to release a small amount of fluoride to the tooth surface and help prevent some decalcification. Studies concerning the impact of this glass ionomer, however, are somewhat mixed. Glass ionomer cements bonds the bracket to the tooth with considerably less strength than does conventional bonding cements. Most dentists still use conventional bonding cements because of the desired bonding strength to the enamel surface. When an orthodontic bracket is bonded to a tooth with a conventional bonding cement, a dentist would usually use an enamel surface sealant. Enamel sealants eventually wear away, such as in three to twenty-four months, and bacteria can still attack the enamel around the sealant.

An orthodontic bracket typically holds an arch wire which moves the tooth and allows the tooth to be moved along. The arch wire is tied in with a ligature or nowadays usually an elastic ligature. Ligatures or elastic ligatures known and used for this purpose are made of polyurethane or other elastomeric material.

Some orthodontic bracket systems have an attached cover and require no elastic ligature. These are frictionless systems and are very expensive and represent a smaller minority of the orthodontic brackets used today

### SUMMARY OF THE INVENTION

In at least one embodiment of the present invention, an elastic ligature is provided which is made of or which has been impregnated with fluoride in various strengths to leach fluoride on to a tooth surface to strengthen the enamel surface and thereby help prevent decalcification. The release and/or dispersion of fluoride in the oral cavity would typically have to be under harmful dosages and probably would be under one or two parts part per million.

In accordance with an embodiment of the present invention, an elastic ligature would be configured to time disperse a certain amount of flouride at a certain rate on a time dispersed basis. The rate of dispersion of fluoride, in accordance with an embodiment of the present invention, would be below, and preferably well below, harmful dosages for rates of dispersion of flouride in a person's mouth. The optimum rates of dispersion of fluoride from the elastic ligature would need to be established by clinical trials. The optimum rates of dispersion of fluoride would need to be significant enough so that the fluoride inhibits and/or resists tooth decay and/or tooth decalcification, but the also small enough so that the dispersion of flouride is not harmful to a person, in which the elastic ligature resides.

As only one possible example, the percentage of fluoride used in toothpaste may be a guideline or an initial outside limit for determining the percentage of fluoride in the overall material which is released from an impregnated elastic ligature in accordance with an embodiment of the present invention. The percentage of sodium fluoride in some known toothpastes is 0.24% and the percentage of stannous fluoride is 0.454%. In other words, the elastic ligature may be embedded with a material which leaches or is time dispersed onto a tooth surface wherein the material may be comprised of at most 0.24% sodium fluoride or at most 0.454% stannous fluoride. The actual percentage of the fluoride in the material that leaches onto the tooth surface may be much less than is leached by tooth pastes. Elastic ligatures, in accordance with embodiments of the present invention, are configured to stay in a patient's mouth for many weeks, and it would be dangerous to have too much fluoride leached out into the patient's mouth and potentially be ingested by the patient over many weeks. The exact formulation of the fluoride would in all likelihood need to be adjusted based on actual patient trials. Generally, the fluoride would have to be under one or two parts per million of the material which leaches out, i.e. which is dispersed in the patient's mouth.

Elastic ligatures are generally replaced every two to six weeks and can be easily modified. In at least one embodiment of the present invention, the elastic ligatures also contain a calcium phosphate compound which has been shown to partially help recalcify surface enamel. The calcium and phosphate ions refortify the enamel surface with calcium and phosphate. Enamel surfaces of teeth, generally loose some amount of calcium and phosphate over time due mainly to the action of bacteria, so impregnated elastic ligatures in accordance with an embodiment of the present invention, help to replace this lost calcium and phosphate. The most active form of calcium phosphate presently available is believed to be amorphous calcium phosphate, and this form may be used to impregnate the elastic ligatures in accordance with an embodiment of the present invention. The formulation of calcium phosphate to be used and the dosage required may need to be adjusted with actual patient trials.

In one or more embodiments of the present invention, the elastic ligatures may contain fluoride and calcium phosphate as separate chemicals or a chemical combination of fluoride and calcium phosphate. The combination of fluoride and calcium phosphate may range from 1% fluoride and 99% calcium phosphate to 50% fluoride and 50% calcium phosphate. The fluoride and/or calcium phosphate may coat the surface of the elastic ligature or could be formulated as a constituent part of an elastomeric material, which along with the fluoride and/or calcium phosphate, and further components, may make up an elastic ligature in accordance with an embodiment of the present invention. As the ligature leaches into the oral cavity, it would disperse its composition. The terms “leaching” and “dispersing” as used in the present application, may typically achieve the same end result. “Leaching”, generally, may have been previously used to imply unintended consequence and not necessarily by design, whereas “dispersing” may have been previously used to imply intended design. However, in the present application, the “leaching” effect or the “dispersing” effect, i.e. the “leaching” of fluoride and/or calcium phosphate is taken advantage of in embodiments of the present invention, and thus is intended and/or by design. There could be a single dose exposure or more of a time dispersed formula.

In addition, elastic ligatures also typically come in chains or power chains to move or consolidate tooth positions. In accordance with another embodiment of the present invention, power chains of ligatures are impregnated with fluoride or a combination or fluoride and calcium phosphate. In another embodiment of the present invention orthodontic caps, impregnated with fluoride or a combination of fluoride and calcium phosphate may be provided which go on top of dental brackets for more surface area for applying the previously mentioned chemicals for problem teeth. These orthodontic caps may provide larger amounts of fluoride or calcium phosphate for problem teeth.

In at least one embodiment of the present invention an apparatus is provided comprising a device including fluoride, wherein the device is configured to be held by a dental bracket and to hold a dental arch wire in place. The device may alternatively, or additionally, include calcium phosphate. The device may be a dental ligature or a dental cap. The apparatus may include the dental bracket. The fluoride may be configured to leach out of the device as part of a material which leaches out of the device, and the amount of fluoride in the material may be less than one part of fluoride per million parts of material.

At least one embodiment of the present invention may include a method comprised of placing a device including fluoride in a person's mouth so the device is held by a dental bracket and holds a dental arch wire in place. The device may be as previously described. The method may also include removing the device from the person's mouth and from the dental bracket after a time period of two to six weeks.

### BRIEF DESCRIPTION OF THE DRAWINGS

FIG. 1 shows front, top, right side perspective view of a dental bracket known in the prior art;

FIG. 2 shows a rear planar view of the dental bracket of FIG. 1;

FIG. 3 shows a front planar view of the dental bracket of FIG. 1;

FIG. 4 shows a right side planar view of the dental bracket of FIG. 1;

FIG. 5 shows a left side planar view of the dental bracket of FIG. 1;

FIG. 6 shows a top planar view of the dental bracket of FIG. 1;

FIG. 7 shows a bottom planar view of the dental bracket of FIG. 1;

FIG. 8 shows a front, top right side perspective view of the dental bracket of FIG. 1 mounted to a tooth within gums of a person's mouth in accordance with a prior art technique;

FIG. 9 shows a front, top right side perspective view of the dental bracket of FIG. 1 mounted to a tooth within gums of a person's mouth in accordance with a prior art technique and also shows an arch wire passing through the dental bracket in accordance with a prior art technique;

FIG. 10 shows a front, top, right side perspective view of the dental bracket of FIG. 1 mounted to a tooth within gums of a person's mouth and an arch wire passing through the dental bracket as in FIG. 9, and additionally shows an elastic ligature attached to the dental bracket in accordance with an embodiment of the present invention;

FIG. 11 shows a front, top, right side perspective view of the dental bracket of FIG. 1 mounted to a tooth within gums of a person's mouth and an arch wire passing through the dental bracket as in FIG. 9, and additionally shows dashed lines to represent a cap attached to the dental bracket in accordance with an embodiment of the present invention; and

FIG. 12 shows a right side view of the cap of FIG. 11, attached to the dental bracket of FIG. 1 in accordance with an embodiment of the present invention.

### DETAILED DESCRIPTION OF THE DRAWINGS

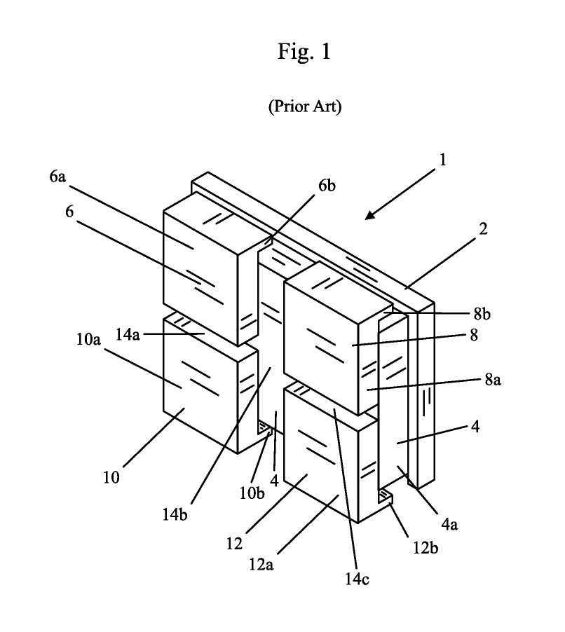

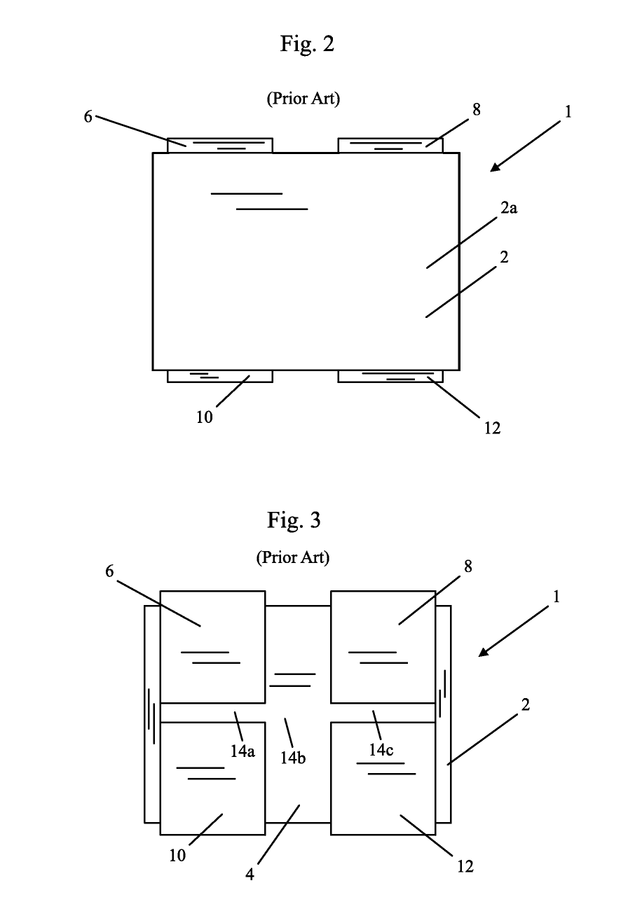

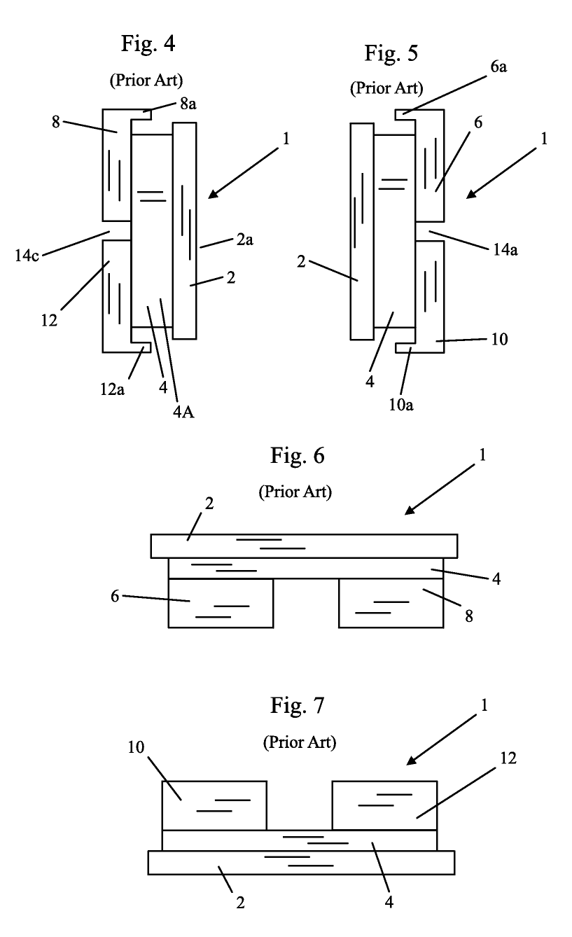

FIG. 1 shows front, top, right side perspective view of a dental bracket 1 known in the prior art. FIGS. 2-7 show rear, front, right side, left side, top and bottom planar views of the dental bracket 1 of FIG. 1.

Referring to FIGS. 1-7, the dental bracket 1 may be an orthodontic dental bracket. The dental bracket 1 includes members, 2, 4, 6, 8, 10, and 12. The members 6, 8, 10, and 12 include a body portions 6a, 8a, 10a, and 12a, and overlapping flange or protrusions 6b, 8b, 10b, and 12b, respectively. There is a slot or gap 14a between members 6 and 10, and a slot or gap 14c between members 8 and 12. There is a slot or gap 14b which is between members 6 and 8 and between members 10 and 12. Each of the members 2, 4, 6, 8, 10, and 12 may be made of metal such as stainless steel or titanium, or may be made from ceramic materials, such as clear ceramic materials. The members 2, 4, 6, 8, 10, and 12 may be integrated together into a single unit.

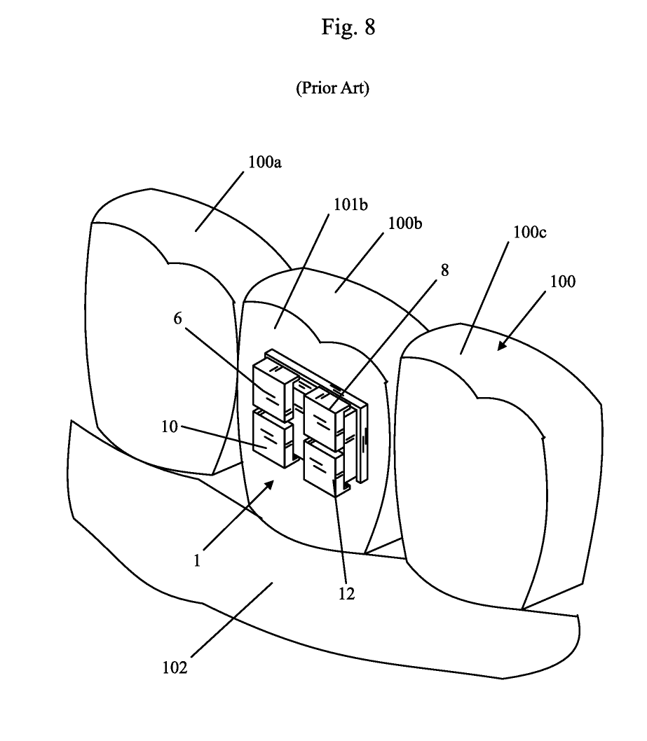

FIG. 8 shows a front, top right side perspective view of the dental bracket 1 of FIG. 1 mounted to a tooth 100b within gums 102 of a person's mouth in accordance with a prior art technique. FIG. 8 also shows teeth 100a and 100c, which along with tooth 100b make up a plurality of teeth 100. The dental bracket 1 may be mounted to the tooth 100b in any known manner such as a composite bonding cement or other dental cement. The dental bracket 1 may be mounted to the tooth 100b by applying a composite bonding cement or other dental cement to a surface 2a, shown in FIG. 2, of the member 2 and adhering or gluing the surface 2a to a surface 101b of the tooth 100b.

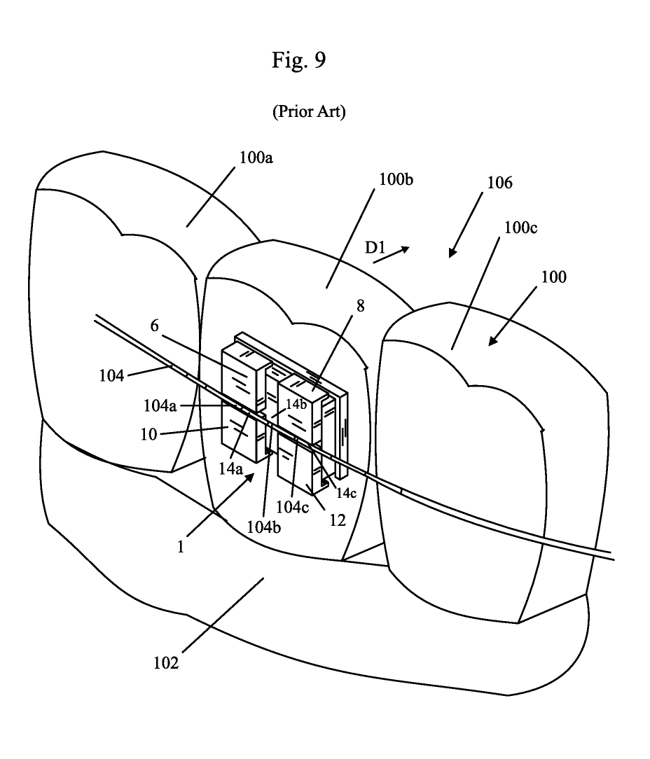

FIG. 9 shows a front, top right side perspective view of the dental bracket 1 of FIG. 1 mounted to the tooth 100b within gums 102 of a person's mouth in accordance with a prior art technique and also shows an arch wire 104 passing through the dental bracket 1 in accordance with a prior art technique. The arch wire 104 includes portions 104a, 104b, and 104c, which are located in slots 14a, 14b, and 14c respectively, of the dental bracket 1. As known in the art, the arch wire 104 may be used to pull or otherwise apply force to the dental bracket 1, which is mounted and/or fixed to the tooth 100b, in order to apply force to the tooth 100b to force the tooth 100b to move in a direction, such as in a direction D1, in towards a mouth 106, as shown in FIG. 9.

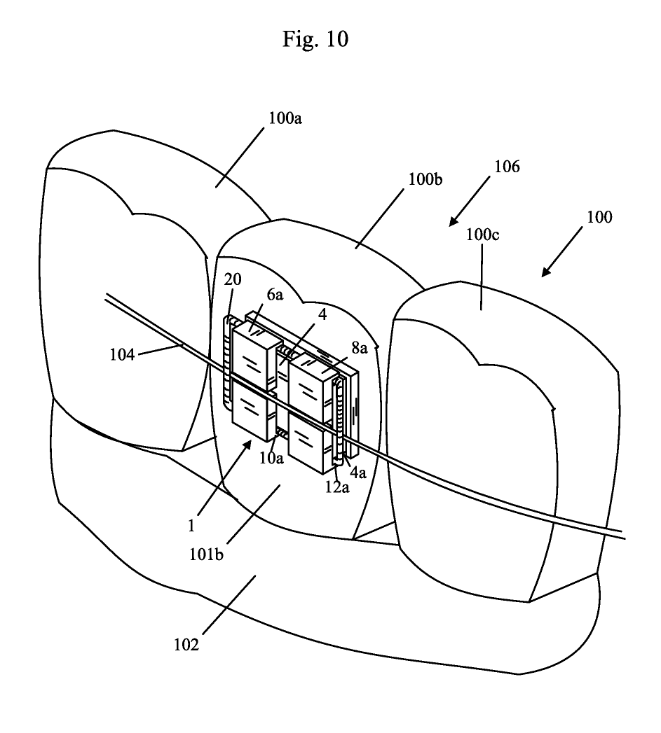

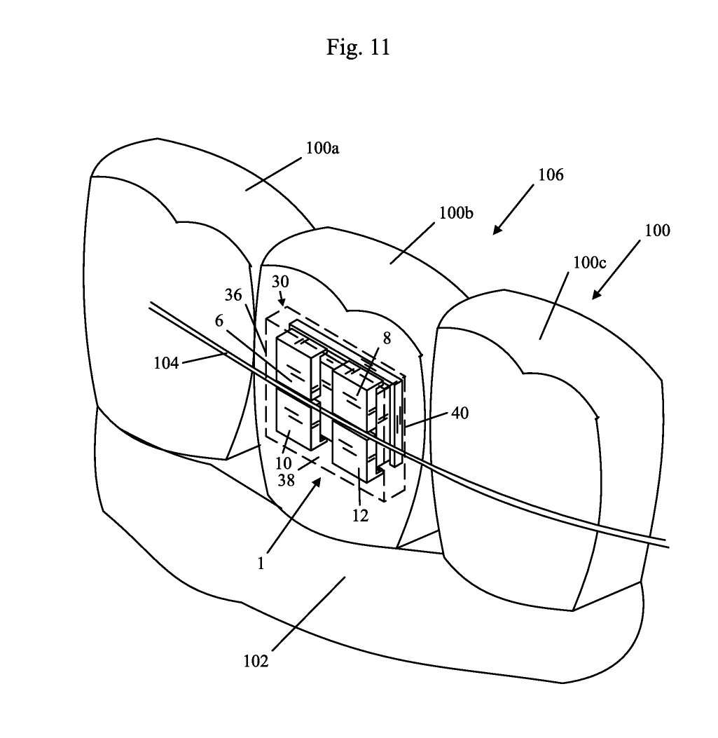

FIG. 10 shows a front, top, right side perspective view of the dental bracket 1 of FIG. 1 mounted to the tooth 100b within gums 102 of the person's mouth 106 and the arch wire 104 passing through the dental bracket 1 as in FIG. 9, and additionally shows an elastic ligature 20 attached to the dental bracket 1 in accordance with an embodiment of the present invention. The elastic ligature 20 may be in the shape of a closed loop, circle, square, oval, or rectangle. The elastic ligature 20 may fit under the flanges or protrusions 6a and 8a and over the flanges or protrusions 10a and 12a, and may simultaneously fit around a perimeter 4a of the member 4, in order to attach the elastic ligature 20 to the bracket 1, as shown in FIG. 10. At the same time, the elastic ligature 20 may also fit over the arch wire 104.

In accordance with an embodiment of the present invention, the elastic ligature 20 may be impregnated with or may contain fluoride in various strengths to leach fluoride on to a tooth surface, such as tooth surface 101b shown in FIG. 10, to strengthen the enamel surface on surface 101b and thereby help prevent decalcification of enamel surface 101b. The release of fluoride from the elastic ligature 20, and into an oral cavity, not identified, would typically have to be under harmful dosages and probably would be under one part per million. The percentage of fluoride in toothpaste of 0.24% sodium fluoride or 0.454% stannous fluoride would typically be the upper limits of the percentages of those respective fluorides. In other words, the elastic ligature 20 would need to be embedded with a material which leaches onto the tooth surface 101b, wherein the material would be comprised of at most 0.24% sodium fluoride or 0.454% stannous fluoride and the other part of the material may be comprised of non harmful materials, such as non-harmful materials that are used in toothpastes or mouth washes. The exact formulation of the fluoride may need to be adjusted based on actual patient trials.

Elastic ligatures, such as elastic ligature 20, are generally replaced every 4-6 weeks and can be easily modified. In at least one embodiment of the present invention, the elastic ligature 20 also contains a calcium phosphate compound which has been shown to partially help recalcify surface enamel, such as on surface 101b shown in FIG. 10. The calcium and phosphate ions refortify the enamel surface, such as on surface 101b, with calcium and phosphate. Enamel surfaces of teeth, generally loose some amount of calcium and phosphate over time due mainly to the action of bacteria, so impregnated elastic ligatures, such as elastic ligature 20, in accordance with an embodiment of the present invention, help to replace this lost calcium and phosphate. The most active form of calcium phosphate presently available is believed to be amorphous calcium phosphate, and this form may be used to impregnate the elastic ligatures, such as elastic ligature 20, in accordance with an embodiment of the present invention. The formulation of calcium phosphate to be used and the dosage required may need to be adjusted with actual patient trials.

The combination of fluoride and calcium phosphate impregnated in the elastic ligature, in accordance with an embodiment of the present invention, may range from 5% fluoride and 95%, to calcium phosphate to 50% fluoride and 50% calcium phosphate. The fluoride and for calcium phosphate may coat the surface of the elastic ligature 20 or could be formulated as an constituent part of the elastic ligature, such as elastic ligature 20. As the ligature leaches into the oral cavity, it would disperse its composition of fluoride and calcium phosphate. There could be a single dose exposure or more of a time release formula.

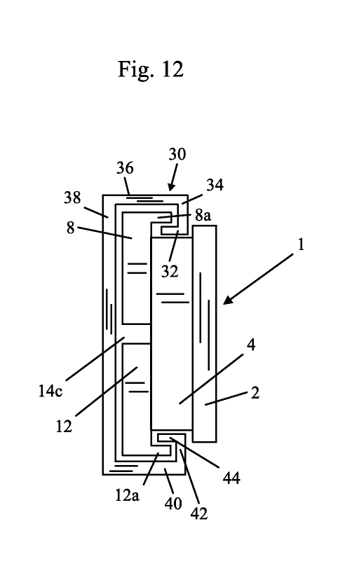

In addition, elastic ligatures also typically come in chains or power chains to move or consolidate tooth positions. In accordance with another embodiment of the present invention, power chains of ligatures are impregnated with fluoride or a combination or fluoride and calcium phosphate. In another embodiment of the present invention, orthodontic caps, such as cap 30 shown in FIG. 11 and FIG. 12, impregnated with fluoride or a combination of fluoride and calcium phosphate may be provided which go on top of dental brackets, such as dental bracket 1, as shown by FIG. 11 and FIG. 12, for more surface area for applying the previously mentioned chemicals for problem teeth. The cap 30 may be used to provide larger amounts of fluoride or calcium phosphate to problem teeth.

FIG. 11 shows a front, top, right side perspective view of the dental bracket 1 of FIG. 1 mounted to the tooth 100b within the gums 102 of a person's mouth 106 and the arch wire 104 passing through the dental bracket 1 as in FIG. 9, and additionally shows dashed lines to represent a cap 30 attached to the dental bracket 1 in accordance with an embodiment of the present invention. The cap 30 may be include or may be impregnated with flouride and/or calcium phosphate, in similar or identical chemical formulations or configurations and special formulations and configurations as explained with reference to the elastic ligature 20, in accordance with an embodiment of the present invention.

FIG. 12 shows a right side view of the cap 30 of FIG. 11, attached to the dental bracket 1 of FIG. 1 in accordance with an embodiment of the present invention. The cap 30 may include members or sections 32, 34, 36, 38, 40, 42, and 44. The cap 30 may be snapped into place to attach the cap 30 to the bracket 1. When the cap 30 is attached to the bracket 1, the member or flange 32 fits at least partially under and is at least partially overlapped by the protrusion or flange 8a. When the cap 30 is attached to the bracket 1, the member or flange 44 fits at least partially over and is at least partially overlapped by the protrusion or flange 12a. In addition a combination of the members 36, 38, and 40, surround the members 6, 8, 10, and 12 when the cap 30 is attached to the bracket 1.

Either the ligature 20 or the cap 30 may be considered to be a device, which may include fluoride and/or calcium phosphate in accordance with one or more embodiments of the present invention.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a device including fluoride; and
wherein the device is configured to be held by a dental bracket and to hold a dental arch wire in place.

2. The apparatus of claim 1 wherein
the device also includes calcium phosphate.

3. An apparatus comprising:
a device including calcium phosphate; and
wherein the device is configured to be held by a dental bracket and to hold a dental arch wire in place.

4. The apparatus of claim 1 wherein
the device is a dental ligature.

5. The apparatus of claim 1 wherein
the device is a cap

6. The apparatus of claim 1 further comprising
the dental bracket.

7. The apparatus of claim 2 further comprising
the dental bracket.

8. The apparatus of claim 3 further comprising
the dental bracket.

9. The apparatus of claim 1 wherein
the fluoride is configured to leach out of the device as part of a material which leaches out of the device; and
wherein the amount of fluoride in the material is less than one part of fluoride per million parts of material.

10. The apparatus of claim 3 wherein
the device is a dental ligature.

11. The apparatus of claim 3 wherein
the device is a cap

12. A method comprising:
placing a device including fluoride in a person's mouth so the device is held by a dental bracket and holds a dental arch wire in place.

13. The method of claim 12 wherein
the device also includes calcium phosphate.

14. A method comprising
placing a device including calcium phosphate in person's mouth so that the device is held by a dental bracket and holds a dental arch wire in place.

15. The method of claim 12 wherein
the device is a dental ligature.

16. The method of claim 12 wherein
the device is a cap

17. The method of claim 12 wherein
the fluoride is configured to leach out of the device as part of a material which leaches out of the device; and
wherein the amount of fluoride in the material is less than one part of fluoride per million parts of material.

18. The method of claim 14 wherein
the device is a dental ligature.

19. The method of claim 14 wherein
the device is a cap.

20. The method of claim 14 further comprising
removing the ligature from the person's mouth and from the dental bracket after a time period of between two to six weeks.
